(19) United States
(12) Patent Application Publication
(10) Pub. No.: US 2026/0148996 A1
(43) Pub. Date: May 28, 2026

(54) FLUOROCARBON-BASED MONOMOLECULAR COMPOUND, SELF-ASSEMBLED MONOLAYER USING SAME, CURRENT COLLECTOR USING SAME, ALL-SOLID-STATE BATTERY USING SAME, AND MANUFACTURING METHOD THEREFOR

(71) Applicant: POSTECH Research and Business Development Foundation, Pohang-si (KR)

(72) Inventors: Sang-Min LEE, Pohang-si (KR); Chanmyeong KIM, Pohang-si (KR); Sangheum JO, Pohang-si (KR)

(73) Assignee: POSTECH Research and Business Development Foundation, Pohang-si (KR)

(21) Appl. No.: 19/398,420

(22) Filed: Nov. 24, 2025

(30) Foreign Application Priority Data
Nov. 27, 2024 (KR) 10-2024-0171959
Oct. 30, 2025 (KR) 10-2025-0160347

(51) Int. Cl. H01M 4/62; C07F 9/113; C09D 5/08; C09D 7/20; C09D 7/63; H01M 4/66

(52) U.S. Cl. CPC H01M 4/628; C07F 9/113; C09D 5/086; C09D 7/20; C09D 7/63; H01M 4/661

(57) ABSTRACT

Provided herein are a monomolecular compound for self-assembly, a self-assembled monolayer using same, a current collector using same, an all-solid-state battery using same, and a manufacturing method therefor, wherein the monomolecular compound comprises: a functional group containing fluorine (F); a spacer including CₓF₂ₓ (6≤x≤12) or CₓF₂ₓ₋₄H₄ (6≤x≤12); and a reactive group containing phosphorus (P) or silicon (Si).

### CROSS-REFERENCE TO RELATED APPLICATION(S)

This application is based on and claims priority under 35 U.S.C. 119 to Korean Patent Application No. 10-2024-0171959, filed on Nov. 27, 2024, and Korean Patent Application No. 10-2025-0160347, filed on Oct. 30, 2025, in the Korean Intellectual Property Office, the disclosure of which is herein incorporated by reference in its entirety.

### BACKGROUND OF THE INVENTION

### 1. Field of the Invention

The present disclosure relates to a fluorocarbon-based monomolecular compound applicable to corrosion-resistant current collectors, a self-assembled monolayer using such a monomolecular compound, a current collector and an all-solid-state battery employing same, and a method for manufacturing the self-assembled monolayer.

### 2. Description of the Prior Art

Conventional lithium secondary batteries employ liquid electrolytes and are prone to ignition when exposed to moisture in air, thereby posing safety issues. These safety concerns have become more prominent with the widespread adoption of electric vehicles. Accordingly, to improve safety, research has recently been actively conducted on all-solid-state secondary batteries, also referred to as all-solid-state batteries, which employ solid electrolytes composed of inorganic materials.

All-solid-state batteries, which solve the safety issues arising from electrolyte leakage or overheating, are attracting attention as next-generation secondary batteries offering high energy density, high output, and long cycle life. Such all-solid-state batteries generally include a cathode layer, a solid electrolyte layer, and an anode layer, wherein the solid electrolyte layer is required to have high ionic conductivity and low electronic conductivity.

Copper, having excellent electrical conductivity and stability, is typically used as the anode current collector in all-solid-state batteries in the form of a thin copper foil. However, in the case of all-solid-state batteries employing sulfide-based solid electrolytes, the copper foil may corrode due to corrosive gases containing sulfur. When the copper foil corrodes, the anode layer of the all-solid-state battery deteriorates, resulting in reduced electrochemical performance.

To prevent corrosion of the copper foil, it is necessary to form on the copper foil a uniform and defect-free coating layer that blocks the permeation of corrosive gas molecules. Conventionally, inorganic coating layers have been deposited onto copper foils using as physical vapor deposition (PVD), including methods such sputtering. However, such coating layers may still contain defects. Moreover, conventional coating processes are complicated and costly.

### SUMMARY OF THE INVENTION

An aspect of the present disclosure is to provide a current collector having corrosion resistance against corrosive gases.

Provided according to an embodiment of the present disclosure is a monomolecular compound for self-assembly, the monomolecular compound including: a functional group bearing fluorine (F); a spacer including CₓF₂ₓ (6≤x≤12) or CₓF₂ₓ₋₄H₄ (6≤x≤12); and a reactive group bearing phosphorus (P) or silicon (Si).

An embodiment of the present disclosure provides the monomolecular compound wherein x in CₓF₂ₓ or CₓF₂ₓ₋₄H₄ satisfies 8≤x≤10.

Another embodiment of the present disclosure provides the monomolecular compound wherein the CₓF₂ₓ includes at least one of C₈F₁₆, C₉F₁₈, C₁₀F₂₀, C₁₁F₂₂, and C₁₂F₂₄, or the CₓF₂ₓ₋₄H₄ includes at least one of C₈H₄F₁₂, C₉H₄F₁₄, C₁₀H₄F₁₆, C₁₁H₄F₁₈, and C₁₂H₄F₂₀.

An embodiment of the present disclosure provides a self-assembled monolayer including the above-described monomolecular compound.

Another embodiment of the present disclosure provides the self-assembled monolayer wherein the van der Waals force between the monomolecules is 32 kJ/mol to 40 kJ/mol (both inclusive).

An embodiment of the present disclosure provides a current collector for an all-solid-state battery, the current collector being coated with the above-described self-assembled monolayer.

An embodiment of the present disclosure provides the current collector wherein the current collector includes copper.

An embodiment of the present disclosure provides an all-solid-state battery comprising an electrode layer and a solid electrolyte layer, wherein the electrode layer includes the current collector coated with the above-described self-assembled monolayer.

An embodiment of the present disclosure provides the solid electrolyte layer that includes a sulfide-based solid electrolyte.

An embodiment of the present disclosure provides the all-solid-state battery wherein the electrode layer includes a copper foil.

An embodiment of the present disclosure provides a method for manufacturing a self-assembled monolayer, the method comprising the steps of: (A) mixing CₓF₂ₓ₊₁OH (6≤x≤12) or CₓF₂ₓ₋₃H₅OH (6≤x≤12) with an aprotic polar solvent; (B) adding a reagent that imparts anchoring properties to the mixture obtained in step (A) to synthesize a monomolecular compound; (C) mixing the monomolecular compound with a solvent to prepare a coating solution; and (D) applying the coating solution onto an anode current collector.

An embodiment of the present disclosure provides the method for manufacturing a self-assembled monolayer, wherein the self-assembled monolayer includes a spacer including at least one of C₈F₁₆, C₉F₁₈, C₁₀F₂₀, C₁₁F₂₂, C₁₂F₂₄, C₉H₄F₁₂, C₉H₄F₁₄, C₁₀H₄F₁₆, C₁₁H₄F₁₈, and C₁₂H₄F₂₀.

Another embodiment of the present disclosure provides the method for manufacturing a self-assembled monolayer, wherein the aprotic polar solvent includes at least one of tetrahydrofuran (THF), dimethylformamide (DMF), acetonitrile, and dimethyl sulfoxide (DMSO).

Another embodiment of the present disclosure provides the method for manufacturing a self-assembled monolayer, wherein the reagent includes at least one selected from phosphoryl chloride (POCl₃), potassium permanganate (KMnO₄), pyridinium chlorochromate, 2,2,6,6-tetramethylpiperidine 1-oxyl (TEMPO), and a CrO₃/H₂SO₄ mixed reagent.

Another embodiment of the present disclosure provides the method for manufacturing a self-assembled monolayer, wherein step (B) is carried out at a temperature of 0 to 100° C.

Another embodiment of the present disclosure provides the method for manufacturing a self-assembled monolayer, wherein 15-20 mL of the aprotic polar solvent, 300-500 mg of CₓF₂ₓ₊₁OH or CₓF₂ₓ₋₃H₅OH, and 150 mg-6 g of the reagent are mixed.

Another embodiment of the present disclosure provides the method for manufacturing a self-assembled monolayer, wherein when the CₓF₂ₓ₊₁OH or CₓF₂ₓ₋₃H₅OH and the reagent are used in amount of n and m moles, respectively, n/m is 0.5 or less.

Another embodiment of the present disclosure provides the method for manufacturing a self-assembled monolayer, wherein, in step (C), the monomolecular compound is mixed at a concentration of 0.001 to 100 mM with the solvent.

Another embodiment of the present disclosure provides the method for manufacturing a self-assembled monolayer, wherein the solvent in step (C) is tetrahydrofuran (THF) or a mixed solvent of isopropyl alcohol and an alkane.

Another embodiment of the present disclosure provides the method for manufacturing a self-assembled monolayer, wherein the alkane includes at least one of hexane (C₆H₁₄), heptane (C₇H₁₆), octane (C₈H₁₈), nonane (C₉H₂₀), decane (C₁₀H₂₂), undecane (C₁₁H₂₄), and dodecane (C₁₂H₂₆).

According to embodiments of the present disclosure, coating a self-assembled monolayer on the surface of a current collector can prevent the current collector from corroding due to corrosive gases generated from a sulfide-based solid electrolyte.

In addition, according to embodiments of the present disclosure, corrosion of the current collector can be prevented, thereby improving the electrochemical characteristics of the all-solid-state battery.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a cross-sectional view illustrating the structure of an all-solid-state secondary battery according to an embodiment of the present disclosure.

FIG. 2 is a schematic view showing a self-assembled monolayer coated on an anode current collector according to an embodiment of the present disclosure.

FIGS. 3A and 3B are photographic images showing corrosion evaluation results of a comparative example.

FIGS. 4A and 4B are photographic images showing corrosion evaluation results of an embodiment.

FIG. 5 is a diagram showing XPS analysis results of a comparative example.

FIG. 6 is a diagram showing XPS analysis results of an embodiment.

FIG. 7 is another diagram showing XPS analysis results of an embodiment.

FIG. 8 is yet another diagram showing XPS analysis results of an embodiment.

FIG. 9 is a TEM image of an embodiment.

FIG. 10 is an EELS image of an embodiment.

FIG. 11 is a graph comparing evaluation results between an all-solid-state battery according to an embodiment of the present disclosure and an all-solid-state battery of a comparative example.

FIG. 12 is another graph comparing evaluation results between an all-solid-state battery according to an embodiment of the present disclosure and an all-solid-state battery of a comparative example.

FIG. 13 is a flowchart illustrating a method for manufacturing a self-assembled monolayer according to an embodiment of the present disclosure.

### DETAILED DESCRIPTION OF THE EXEMPLARY EMBODIMENTS

Hereinafter, exemplary embodiments disclosed in the present specification will be described in detail with reference to the accompanying drawings. In the drawings, like reference numerals refer to like or similar elements regardless of the figure number, and repeated descriptions thereof will be omitted. In the following description of embodiments of the present disclosure, when each layer (film), region, pattern, or structure is described as being formed “on” or “under” a substrate, another layer (film), region, pattern, or structure, the terms “on” and “under” include both “directly” formed and “indirectly” formed cases through another layer. In addition, the reference for “on” or “under” of each layer is based on the drawings. The thickness or size of each layer illustrated in the drawings may be exaggerated, omitted, or schematically represented for convenience of explanation and clarity, and the actual dimensions may not necessarily reflect the exact proportions.

In the present description, expressions such as “comprising,” “including,” or “having” are intended to specify the presence of stated features, numbers, steps, operations, elements, or combinations thereof, but are not intended to preclude the presence or possibility of one or more other features, numbers, steps, operations, elements, or combinations thereof that are not expressly stated.

Also, terms such as “first,” “second,” and the like may be used to describe various components, but these components are not limited by such terms, which are merely used to distinguish one component from another.

In addition, in describing the embodiments disclosed in the present specification, when it is determined that a detailed description of related known techniques would obscure the gist of the embodiments disclosed herein, such description will be omitted.

The accompanying drawings are provided merely to facilitate understanding of the embodiments disclosed herein and should not be construed as limiting the technical scope of the present disclosure. It should be understood that all modifications, equivalents, and alternatives that fall within the spirit and scope of the present invention are encompassed thereby.

The term “about,” as used herein, denotes a conventional tolerance range that would be readily recognized by those skilled in the art and may refer to within +5% of the specified value.

Below, a detailed description will be given of the present disclosure with reference to the drawings.

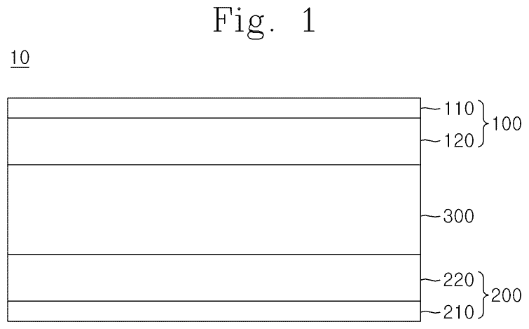

FIG. 1 is a cross-sectional view illustrating the structure of an all-solid-state battery according to an embodiment of the present disclosure.

The all-solid-state battery 10 according to an embodiment of the present disclosure includes a cathode layer 100, an anode layer 200, and a solid electrolyte layer 300. The solid electrolyte layer 300 is disposed between the cathode layer 100 and the anode layer 200. The cathode layer 100 includes a cathode current collector 110 and a cathode active material layer 120, and the cathode active material layer 120 is disposed on the cathode current collector 110. The anode layer 200 includes an anode current collector 210 and an anode active material layer 220, and the anode active material layer 220 is disposed on the anode current collector 210.

### [Cathode Layer]

The cathode current collector 110 may employ, for example, a plate or foil made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

The cathode active material layer 120 may include, for example, a cathode active material and a solid electrolyte. The solid electrolyte included in the cathode layer 100 may be same as or different from the solid electrolyte included in the solid electrolyte layer 300.

The cathode active material may include, for example, a lithium transition metal oxide such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate, or a material such as nickel sulfide, copper sulfide, lithium sulfide, iron oxide, or vanadium oxide, but is not limited thereto. So long as it is used in the art, any cathode active material may be available. The cathode active materials may be used alone or as a mixture of two or more types thereof.

In addition, the cathode active material layer 120 may include a conductive material. The conductive material may include, for example, graphite, carbon black, acetylene black, Ketjen black, carbon fibers, or metal powders.

The cathode current collector 110 may have a thickness of about 8-10 μm, and the cathode active material layer 120 may have a thickness of about 80-110 μm.

### [Solid Electrolyte Layer]

The solid electrolyte layer 300 includes a solid electrolyte and is disposed between the cathode layer 100 and the anode layer 200. The solid electrolyte included in the solid electrolyte layer 300 may be a sulfide-based, oxide-based, halide-based, or polymer-based solid electrolyte.

Examples of oxide-based solid electrolytes include perovskite-type LLTO (Li₃ₓLa_{2/3-x}TiO₃) and NASICON-type LATP (Li₁₊ₓAlₓTi₂₋ₓ(PO₄)₃) phosphate-based electrolytes.

The sulfide-based solid electrolyte may include one or more selected from, for example, Li₂S—P₂S₅, Li₂S—P₂S₅—LiX (where X is a halogen element), Li₂S—P₂S₅—Li₂O, Li₂S—P₂S₅—Li₂OLiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂SB₂S₃, Li₂S—P₂S₅-ZmSn (where m and n are positive numbers, and Z is one of Ge, Zn, or Ga), Li₂S—GeS₂, Li₂S—SiS₂—Li₃PO₄, Li₂S—SiS₂-LiₚMO_{q} (where p and q are positive numbers and M is one of P, Si, Ge, B, Al, Ga, or In), Li₇-xPS₆-xClₓ (0≤x≤2), Li₇-xPS₆-xBrₓ (0≤x≤2), and Li₇-xPS₆-xIₓ (0≤x≤2).

The sulfide-based solid electrolyte may be an argyrodite-type compound including one or more selected from Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound including one or more of Li₆PS₅Cl, Li₆PS₅Br, and Li₆PS₅I.

Sulfide-based solid electrolytes are highly sensitive to moisture, and even at a moisture level of several tens of ppm, they react with water to generate corrosive gases such as hydrogen sulfide. When such corrosive gases are generated during the fabrication or charge/discharge process of an all-solid-state battery, the copper foil anode current collector reacts with the corrosive gas, resulting in the formation of copper sulfide on the surface of the anode current collector. This corrosion reaction deteriorates the mechanical and electrochemical properties of the anode current collector, thereby increasing the internal resistance of the all-solid-state battery. As the internal resistance increases, the reversible capacity of the all-solid-state battery decreases, leading to degradation of its cycle-life characteristics.

### [Anode Layer]

The anode active material layer 220 may include lithium metal, a lithium metal alloy, or a combination thereof. Alternatively, the anode active material layer 220 may include one or more selected from the group consisting of lithium-alloyable metals, transition metal oxides, non-transition metal oxides, and carbon-based materials. The anode active material layer 220 may be in the form of a plate or foil.

The lithium-alloyable metal may include, for example, Ag, Si, Sn, Al, Ge, Pb, Bi, Sb, a Si—Y alloy (where Y is an alkali metal, an alkaline earth metal, a group 13 element, a group 14 element, a transition metal, a rare-earth element, or a combination thereof, and Y is not Si), or a Sn—Y alloy (where Y is an alkali metal, an alkaline earth metal, a group 13 element, a group 14 element, a transition metal, a rare-earth element, or a combination thereof, and Y is not Sn). The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include, for example, lithium titanium oxide, vanadium oxide, or lithium vanadium oxide. The non-transition metal oxide may include, for example, SnO₂, or SiOₓ (0<x<2) (0<x<2). The carbon-based material may include crystalline carbon, amorphous carbon, or a mixture thereof. The crystalline carbon may be graphite such as natural graphite or artificial graphite in the form of amorphous, plate-like, flake, spherical, or fibrous particles. The amorphous carbon may include soft carbon (low-temperature fired carbon), hard carbon, mesophase pitch-derived carbon, or calcined coke. The anode active material layer 220 may have a thickness of about 10-30 μm.

The anode current collector 210 may be formed of a material that does not react with lithium. Specifically, the anode current collector 210 may be made of a material that does not form an alloy or compound with lithium. The material constituting the anode current collector 210 may include, for example, copper (Cu), stainless steel, titanium (Ti), iron (Fe), cobalt (Co), or nickel (Ni), but is not limited thereto. So long as it is used in the art, any material may be available for the anode current collector.

The anode current collector 210 may be made of one of the metals described above, or may be composed of an alloy or coated material of two or more of the metals. The anode current collector 210 may be in the form of a plate or foil, and may have a thickness of about 8-10 μm.

The anode current collector 210 according to an embodiment of the present disclosure is coated with a fluorocarbon-based corrosion-resistant self-assembled monolayer (SAM). The self-assembled monolayer is an orderly arranged organic molecular film that spontaneously coats the surface of a given substrate (for example, the anode current collector). With thermodynamically spontaneous self-assembling and surface-anchoring characteristics, the self-assembled monolayer can uniformly and defect-freely coat the surface layer of a specific substrate.

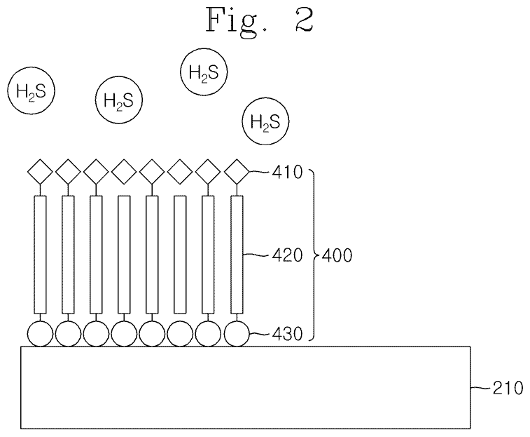

FIG. 2 is a schematic diagram illustrating an anode current collector coated with a self-assembled monolayer (SAM) according to an embodiment of the present disclosure.

Referring to FIG. 2, a monomolecular component constituting the self-assembled monolayer 400 includes a terminal group or functional group 410, a spacer 420, and a head group or reactive group 430.

The functional group 410 is the tail portion of the molecule that determines the functionality of the self-assembled monolayer (400). The functional group 410 includes fluorine F and provides chemical stability so that the self-assembled monolayer 400 is not altered by corrosive gases (for example, H₂S). The functional group 410 may be CF₃.

In order to minimize interactions with polar corrosive gas molecules such as H₂S, the functional group 410 preferably has non-polarity. Therefore, the lower the polarity of the functional group 410 (that is, the smaller its dipole moment), the more effectively it can block the penetration of polar corrosive gas molecules. The low-polarity functional group 410 may include alkyl groups (CH₃, C₂H₅, C₃H₇, C₄H₉, C₅H₁₁, etc.), cycloalkyl groups (cyclopropyl, cyclobutyl, cyclopentyl, cyclohexyl, etc.), or aryl groups (phenyl, benzyl, naphthyl, etc.).

When the functional group 410 contains fluorine (F), the self-assembled monolayer 400 as a whole becomes non-polar because the C—F bond itself is polar, but the fluorine atoms are symmetrically arranged within the molecule.

The spacer 420 forms the main body of the molecule and allows a regular molecular layer to be formed. The spacer 420 has a carbon-containing structure with a molecular formula of CₓF₂ₓ or CₓF₂ₓ₋₄H₄. The spacer 420 provides van der Waals forces between molecules, which enable uniform coating of the self-assembled monolayer (400).

To form a uniform self-assembled monolayer (400), the van der Waals interaction between the molecules forming the monolayer may be in the range of 32 kJ/mol to 40 kJ/mol. If the van der Waals force is less than 32 kJ/mol, self-assembly may not proceed uniformly, and a uniform monolayer may not be formed. Conversely, if the van der Waals force exceeds 40 kJ/mol, aggregation may occur due to excessively strong intermolecular attraction, making it difficult to form a monomolecular coating layer.

The van der Waals interaction between molecules is determined by the molecular composition and molecular length. The molecular length may be determined by the value of x in CₓF₂ₓ or CₓF₂ₓ₋₄H₄. In embodiments of the present disclosure, x may satisfy 2≤x≤20 or 6≤x≤12, and preferably 8≤x≤10. When 8≤x≤10, even though the molecule is relatively short, it can exhibit an appropriate van der Waals force due to high electronegativity. CₓF₂ₓ may include at least one selected from C₈F₁₆, C₉F₁₈, C₁₀F₂₀, C₁₁F₂₂, and C₁₂F₂₄; and CₓF₂ₓ₋₄H₄ may include at least one selected from C₈H₄F₁₂, C₉H₄F₁₄, C₁₀H₄F₁₆, C₁₁H₄F₁₈, and C₁₂H₄F₂₀.

The reactive group 430 is the head portion of the single molecule that binds to the substrate. The reactive group 430 bears phosphorus (P) or silicon (Si) and exhibits strong adhesion to the surface of the anode current collector 210. The reactive group 430 may include PO₄H₂, Si(OCH₃)₃, or Si(OH)₃, and may function as a ligand.

Together with the tetrahedron formed by the oxygen atoms in a phosphate-containing reactive group, the tetrahedral P atom can induce an inductive effect, which enhances ionic bonding between the metal atoms of the current collector (for example, the anode current collector) and the molecules of the self-assembled monolayer (400), thereby forming a stronger bond.

Reactive groups capable of enhancing bonding to the current collector through the inductive effect include, for example, SO₄²⁻, PO₄³⁻, and SiO⁴⁻, where the strength of the inductive effect increases in the order SiO⁴⁻<PO₄³⁻<SO₄²⁻.

Below, a method for manufacturing a self-assembled monolayer 400 according to an embodiment of the present disclosure will be explained.

First, a fluorocarbon-containing primary alcohol is mixed with an aprotic polar solvent to prepare a solution (first solution). The fluorocarbon-containing primary alcohol may be represented by CₓF₂ₓ₊₁OH or CₓF₂ₓ₋₃H₅OH, where x satisfies 2≤x≤20 or 6≤x≤12, and preferably 8≤x≤10. Examples of the fluorocarbon-containing primary alcohol include fluoroalcohols such as C₈F₁₇OH (perfluoro-1-octanol), C₈H₅F₁₃O (1H,1H,2H,2H-perfluoro-1-octanol), C₉F₁₉OH (perfluoro-1-nonanol), C₉H₅F₁₅O (1H,1H,2H,2H-perfluoro-1-nonanol), C₁₀F₂₁OH (perfluoro-1-decanol), C₁₀H₅F₁₇O (1H,1H,2H,2H-perfluoro-1-decanol), C₁₁F₂₃OH (perfluoro-1-undecanol), C₁₁H₅F₁₉O (1H,1H,2H,2H-perfluoro-1-undecanol), C₁₂F₂₅OH (perfluoro-1-dodecanol), and C₁₂H₅F₂₁O (1H,1H,2H,2H-Perfluoro-1-dodecanol). The aprotic polar solvent may be tetrahydrofuran (THF), dimethylformamide (DMF), acetonitrile, or dimethyl sulfoxide (DMSO).

Subsequently, a reagent is added to the first solution at a temperature of 0-100° C. The reagent may be selected from phosphoryl chloride (POCl₃), KMnO₄, pyridinium chlorochromate, 2,2,6,6-tetramethylpiperidine 1-oxyl (TEMPO), or a CrO₃/H₂SO₄ mixed reagent. Preferably, the reagent contains phosphorus (P), and more preferably, the reagent is POCl₃ (phosphoryl chloride). The reagent functions to oxidize the alcohol group (—OH) in the molecule. When the alcohol is oxidized by such a reagent, the resulting molecule acquires an anchoring property, enabling strong adhesion to the surface of the substrate.

The aprotic polar solvent may be used in an amount of 15-20 mL, the fluorocarbon-containing primary alcohol in an amount of 300-500 mg, and the reagent in an amount of 150 mg-6 g. The number of fluorocarbon molecules may be smaller than the number of reagent molecules; that is, when the fluorocarbon-containing primary alcohol is n mol and the reagent is m mol, the ratio n/m may be ≤1, and preferably ≤0.5. For example, when THE is used as the solvent, C₁₀H₅F₁₇O as the primary alcohol, and POCl₃ as the reagent, the molar ratio of C₁₀H₅F₁₇O to POCl₃ may be 1 or less, preferably 0.5 or less. In the present disclosure, the notation “15-20 mL” includes both the upper and lower limits (i.e., 15 and 20 mL are inclusive).

Through a nucleophilic attack of the alcohol group, an esterified monomolecular coating material or monomolecular compound for SAM formation can be obtained. The obtained coating material or compound is dissolved in a solvent at a concentration of 0.001-100 mM and applied to the surface of the anode current collector. The solvent may be THE, or a mixed solvent of an alkane (CₓH₂_{^{x}}₊₂) and an alcohol C_{y}H_{(2y+1)}OH). The mixed solvent may contain 99-100% v/v alkane and 0-1% v/v alcohol. The alkane may be hexane (C₆H₁₄), heptane (C₇H₁₆), octane (C₈H₁₈), nonane (C₉H₂₀), decane (C₁₀H₂₂), undecane (C₁₁H₂₄), or dodecane (C₁₂H₂₆) (6≤x≤12), and the alcohol C_{y}H_{(2y+1)}OH) may be those satisfying the condition of 1≤y≤4.

After the monomolecular coating material is applied to the anode current collector, the coated collector is washed and dried, thereby completing the corrosion-resistant self-assembled monolayer (400) on the anode current collector 210. The washing may be performed using the solvent described above (THF or a mixed solvent of isopropyl alcohol and alkane). Specifically, the coated anode current collector is immersed in 50 mL of solvent for about 10 minutes, removed, and then vacuum-dried at room temperature for 12 hours.

The self-assembled monolayer 400 coated on the anode current collector 210 may have a thickness of 2-4 nm. The thickness of the self-assembled monolayer 400 according to the Example of the present disclosure is sufficient to enhance corrosion resistance while maintaining electron conduction through the tunneling effect. If the self-assembled monolayer 400 is too thin, corrosion resistance deteriorates; if too thick, tunneling may not occur. According to Fick's first law of diffusion, for example, when the thickness of the self-assembled monolayer 400 is 1 nm, the diffusion rate of corrosive gas may be about three times higher than that of a 3 nm layer.

The thickness of the self-assembled monolayer 400 may be measured using transmission electron microscopy-electron energy-loss spectroscopy (TEM-EELS). In this case, the thickness of the F-containing outer coating layer on the anode current collector 210 coated with the self-assembled monolayer is measured to determine the thickness of the SAM 400.

Hereinafter, an experiment on a gas-solid corrosion reaction (non-contact corrosion reaction) between a sulfide-based solid electrolyte and a copper foil current collector is described.

### Comparative Example

Under an environment similar to that of an actual pouch cell manufacturing process, a copper foil anode current collector caused by corrosive gas (H₂S) generated from a sulfide-based solid electrolyte was evaluated for corrosion. The anode current collector and the sulfide-based solid electrolyte were placed in a chamber, and the anode current collector was exposed to the corrosive gas generated from the sulfide-based solid electrolyte. The anode current collector and the sulfide-based solid electrolyte were arranged so as not to be in direct contact with each other.

The evaluation conditions for the Comparative Example were as follows:
Dew point: −30° C.
Solid electrolyte: 200 mg of Li₆PS₅Cl pellet with a diameter of 14 mm
Anode current collector: Copper foil 10 μm in thickness
Concentration of corrosive gas: Up to 20 ppm
Exposure time to corrosive gas: 12 hours

### Example

In an embodiment of the present disclosure, the corrosion resistance of an anode current collector 210 coated with a corrosion-resistant self-assembled monolayer 400 was evaluated. The self-assembled monolayer 400 was coated on the anode current collector 210 as described below.

First, C₁₀H₅F₁₇O (1H,1H,2H,2H-perfluoro-1-decanol) was mixed with an aprotic polar solvent, tetrahydrofuran (THF), to prepare a first solution. Subsequently, phosphoryl chloride (POCl₃) was added to the first solution at 60° C. Specifically, 15 mL of THE, 500 mg of C₁₀H₅F₁₇O, and 6 g of POCl₃ were mixed.

The prepared monomolecular coating material was then dissolved in THE at a concentration of 10 mM and applied onto the surface of the anode current collector. The coated collector was subsequently washed and dried. The thickness of the self-assembled monolayer 400 coated on the anode current collector 210 was measured to be 3 nm. As in the Comparative Example, the corrosion of the copper foil anode current collector 210 caused by corrosive gas (H₂S) generated from a sulfide-based solid electrolyte was evaluated under an environment similar to that of an actual pouch cell manufacturing process. The evaluation conditions were identical to those of the comparative example and were as follows:
Dew point: −30° C.
Solid electrolyte: 200 mg of Li₆PS₅Cl pellet with a diameter of 14 mm
Anode current collector: Copper foil (10 μm thick) coated with the corrosion-resistant self-assembled monolayer 400
Concentration of corrosive gas: Up to 20 ppm
Exposure time: 12 hours

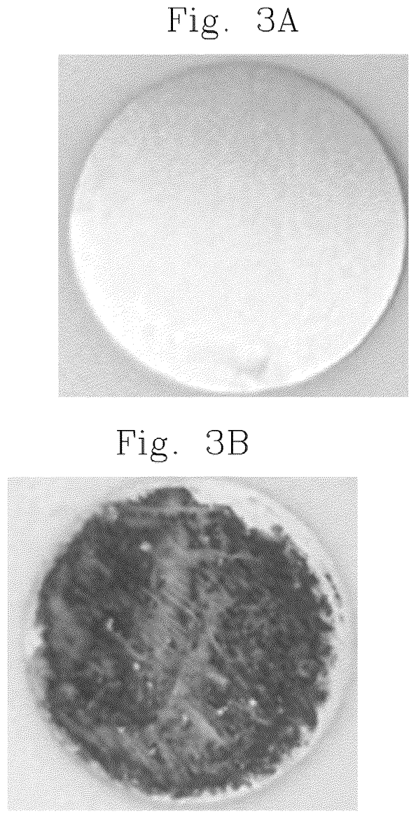

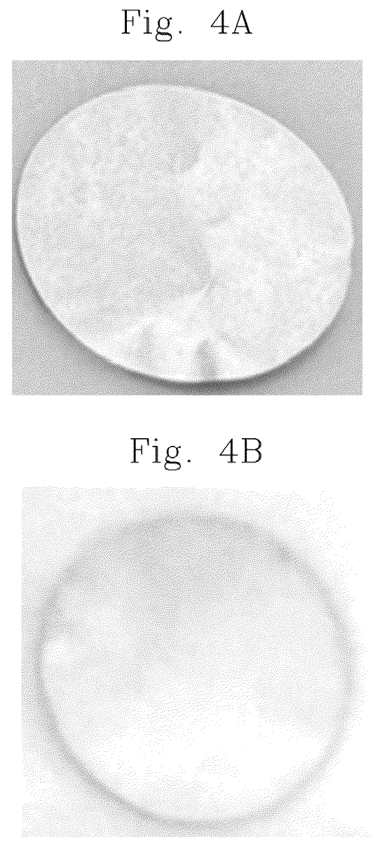

FIGS. 3A and 3B show the corrosion evaluation results of the Comparative Example, and FIGS. 4A and 4B show those of the Example of the present disclosure.

FIGS. 3a and 4a correspond to the anode current collectors before exposure to corrosive gas (H₂S), whereas FIGS. 3b and 4b show the collectors after exposure.

Referring to FIGS. 3A and 3B, under a dew-point environment of −30° C. (relative humidity of approximately 1.6%) containing trace moisture, a non-contact corrosion reaction was observed between the sulfide-based solid electrolyte and the anode current collector. The surface of the copper foil was visibly discolored, indicating that the copper foil was corroded by the corrosive gas generated from the sulfide-based solid electrolyte. This confirms that corrosion occurs when a copper foil is used as an anode current collector for an all-solid-state battery.

In contrast, as shown in FIGS. 4A and 4B, no discoloration was observed in the case of the anode current collector coated with the corrosion-resistant self-assembled monolayer, demonstrating excellent corrosion resistance against the corrosive gas.

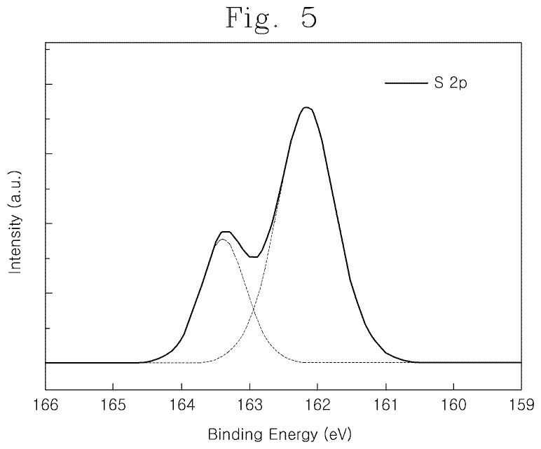

FIG. 5 shows the X-ray photoelectron spectroscopy (XPS) analysis results of the Comparative Example.

X-ray photoelectron spectroscopy (XPS) is a technique that determines the composition and chemical bonding states on a sample surface by irradiating X-rays onto the sample and measuring the kinetic energy of the emitted photoelectrons. FIG. 5 represents the XPS profile of the S2p region of the discolored copper foil anode current collector. With reference to FIG. 5, a distinct peak corresponding to CuS was detected, confirming that the copper foil in the comparative example was corroded by the corrosive gas (H₂S) originating from the sulfide-based solid electrolyte.

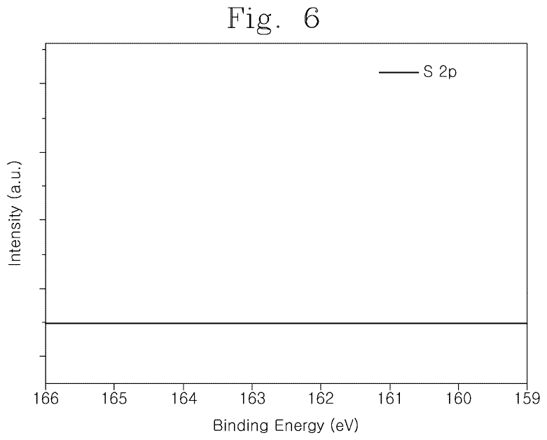

FIG. 6 shows the XPS analysis results of the Example.

FIG. 6 represents an XPS profile for the S2p region of the copper foil anode current collector 210 coated with the corrosion-resistant self-assembled monolayer 400. As shown in FIG. 6, no CuS-related peaks were detected. Therefore, the copper foil anode current collector 210 coated with the corrosion-resistant self-assembled monolayer 400 according to the Example of the present disclosure was not corroded by the corrosive gas generated from the sulfide-based solid electrolyte.

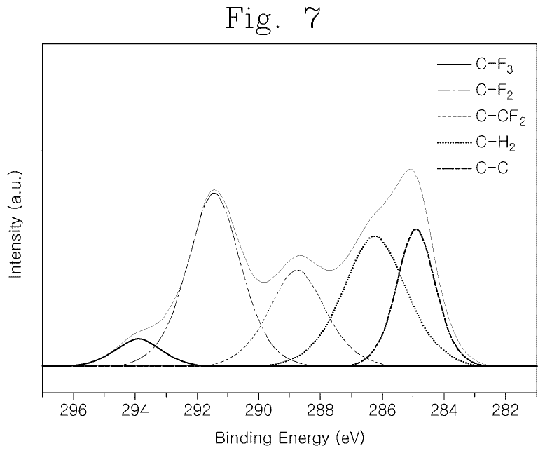

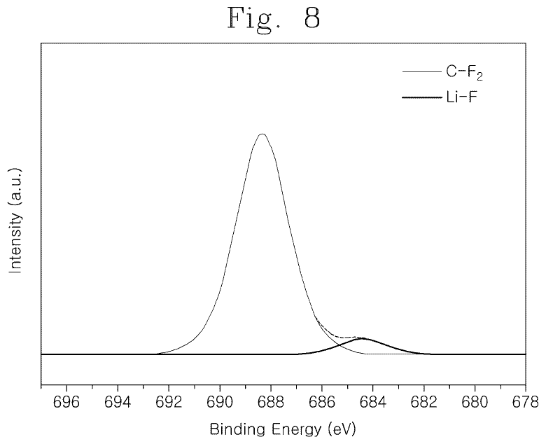

FIG. 7 shows another XPS analysis result of the Example, and FIG. 8 shows yet another XPS analysis result of the Example.

FIG. 7 presents the XPS profile of the C1s region, and FIG. 8 presents that of the F1s region for the copper foil anode current collector 210 coated with the corrosion-resistant self-assembled monolayer 400.

As shown in FIG. 7, peaks corresponding to the C—F bond and the aliphatic hydrocarbon of the spacer (420) were detected.

Furthermore, FIG. 8 confirms the presence of the C—F bond, indicating that the corrosion-resistant self-assembled monolayer 400 was successfully coated on the anode current collector 210.

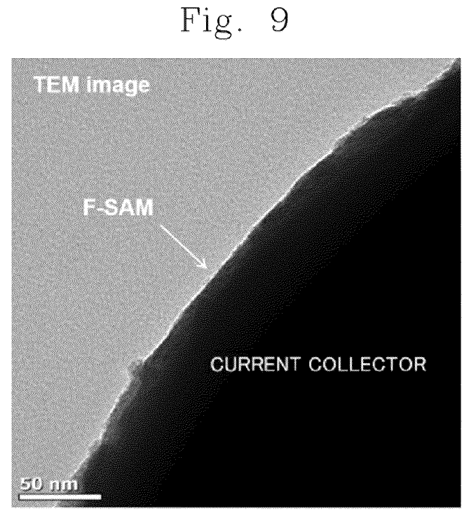

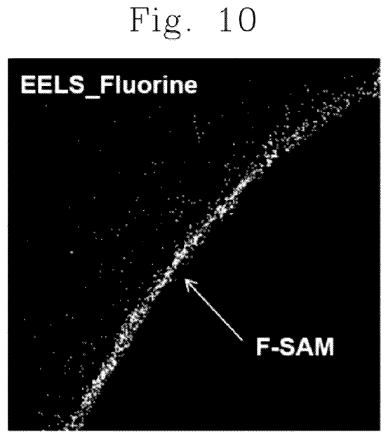

FIGS. 9 and 10 shows a TEM image and an EELS image of the current collector of the Example, respectively.

In FIGS. 9 and 10, “F-SAM” refers to the corrosion-resistant self-assembled monolayer 400 according to the Example of the present disclosure. Referring to FIG. 9, a gray contrast region corresponding to the coating layer of the corrosion-resistant self-assembled monolayer was observed on the surface of the anode current collector 210.

With reference to FIG. 10, EELS mapping (fluorine detection from the self-assembled monolayer coating) of the gray contrast region confirmed that a uniform self-assembled monolayer 400 with a thickness of approximately 3 nm was formed on the surface of the anode current collector 210.

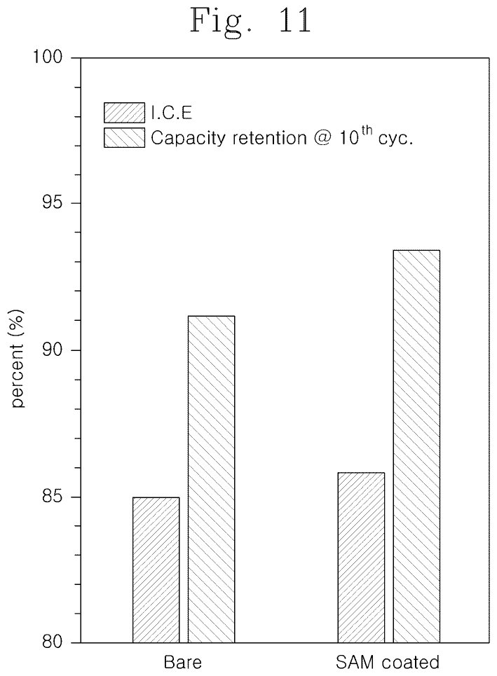

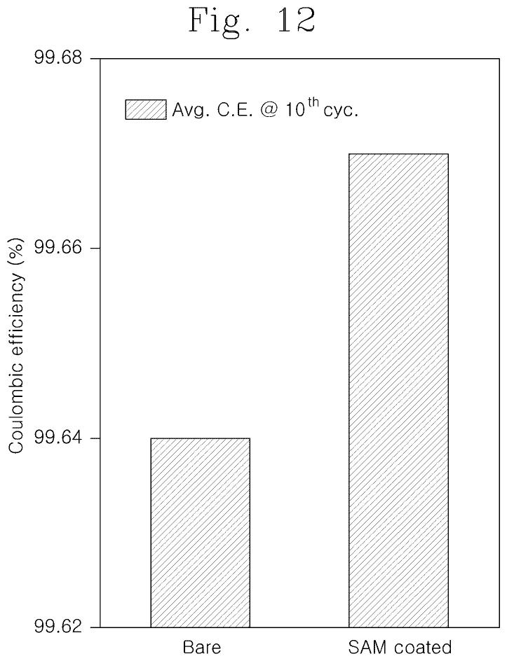

FIGS. 11 and 12 are graphs that compare the electrochemical performance of an all-solid-state battery according to the Example of the present disclosure with that of the Comparative Example.

FIG. 11 shows a graph comparing the initial coulombic efficiency (I.C.E.) and capacity retention, while FIG. 12 shows a graph comparing the average coulombic efficiency (Avg. C.E.), which was calculated as the average value over ten cycles. In FIGS. 11 and 12, “Bare” refers to the Comparative Example, and “SAM coated” refers to the Example. The all-solid-state batteries were fabricated using a combination of NCM811 as the cathode active material, Li₆PS₅Cl as the solid electrolyte, and Li as the anode active material.

Referring to FIGS. 11 and 12, the all-solid-state battery using the anode current collector 210 coated with the corrosion-resistant self-assembled monolayer 400 according to the Example of the present disclosure exhibited higher initial coulombic efficiency, capacity retention, and average coulombic efficiency compared to the comparative example. Therefore, it can be confirmed that the use of the anode current collector 210 coated with the corrosion-resistant self-assembled monolayer 400 according to the Example of the present disclosure improves the electrochemical performance of the all-solid-state battery.

Furthermore, when an anode-less all-solid-state battery composed of Li, Li₆PS₅Cl, and the anode current collector was fabricated and evaluated, the discharge (stripping) efficiency of the all-solid-state battery according to the Example of the present disclosure was found to be 3.68% higher than that of the Comparative Example.

In detail, Li was plated onto the surface of the anode current collector at a current density of 0.1 mA/cm² until reaching 0.5 mAh/cm², followed by discharging (stripping) the Li at a current density of 0.1 mA/cm² until the voltage reached 1.5 V. The discharge efficiency of the comparative example was 86.91%, whereas that of the all-solid-state battery 10 using the anode current collector 210 coated with the corrosion-resistant self-assembled monolayer 400 according to the Example of the present disclosure was 90.59%, which is 3.68% higher. Accordingly, the anode-less all-solid-state battery according to the Example of the present disclosure exhibits enhanced electrochemical performance.

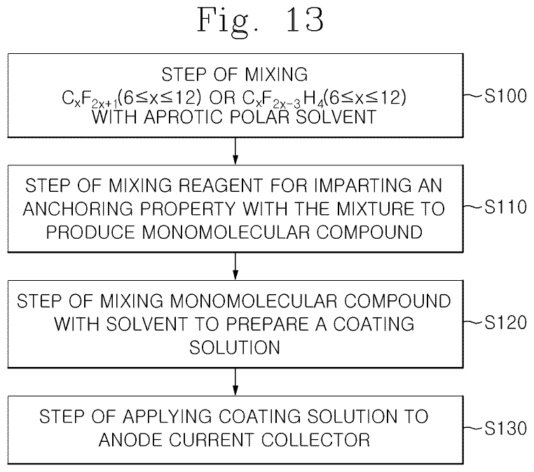

FIG. 13 is a flowchart illustrating a method for manufacturing the self-assembled monolayer according to the Example of the present disclosure.

The manufacturing method of the self-assembled monolayer according to the Example of the present disclosure includes the following steps of: (A) mixing CₓF₂ₓ₊₁OH (6≤x≤12) or CₓF₂ₓ₋₃H₅OH (6≤x≤12) with an aprotic polar solvent (S100); (B) adding a reagent to impart an anchoring property to the mixture of step (A) to produce a monomolecular compound (S110); (C) mixing the monomolecular compound with a solvent to prepare a coating solution (S120); and (D) applying the coating solution to the anode current collector (S130).

The detailed monomolecular compound and method for preparing the self-assembled monolayer are identical to those described above and thus will not be repeated here.

As described above, the present disclosure has been explained with reference to specific components, limited embodiments, and drawings; however, these have been provided merely to facilitate a more comprehensive understanding of the present disclosure. The present disclosure is not limited to the above-described embodiments, and various modifications and variations can be made by those skilled in the art without departing from the essential spirit and scope of the present disclosure. For example, although the embodiments of the present disclosure have been described with respect to the anode current collector 210, the present disclosure is not limited thereto and may also be applied to the cathode current collector 110. Therefore, the spirit of the present disclosure should not be construed as being limited to the described embodiments, and the technical ideas equivalent or equivalent modifications to the following claims should be construed as being included within the scope of protection of the present disclosure. In addition, each of the embodiments described above may be combined and implemented with one another as needed.

What is claimed is:

1. A monomolecular compound for self-assembly,
wherein the monomolecular compound comprises:
a functional group containing fluorine (F);
a spacer including CₓF₂ₓ (6≤x≤12) or CₓF₂ₓ₋₄H₄ (6≤x≤12); and
a reactive group containing phosphorus (P) or silicon (Si).

2. The monomolecular compound of claim 1,
wherein the CₓF₂ₓ or CₓF₂ₓ₋₄H₄ satisfies the condition of 8≤x≤10.

3. The monomolecular compound of claim 1,
wherein the CₓF₂ₓ comprises at least one selected from the group consisting of C₈F₁₆, C₉F₁₈, C₁₀F₂₀, C₁₁F₂₂, and C₁₂F₂₄,
or the CₓF₂ₓ₋₄H₄ comprises at least one selected from the group consisting of C₈H₄F₁₂, C₉H₄F₁₄, C₁₀H₄F₁₆, C₁₁H₄F₁₈, and C₁₂H₄F₂₀.

4. A self-assembled monolayer, comprising the monomolecular compound of claim 1.

5. The self-assembled monolayer of claim 4,
wherein a van der Waals force between the monomolecules ranges from 32 kJ/mol to 40 kJ/mol.

6. A current collector for an all-solid-state battery,
wherein the current collector is coated with the self-assembled monolayer and wherein the self-assembled monolayer comprises the monomolecular compound of claim 1.

7. The current collector of claim 6,
wherein the current collector comprises copper.

8. An all-solid-state battery comprising an electrode layer and a solid electrolyte layer,
wherein the electrode layer comprises the current collector coated with the self-assembled monolayer and wherein the self-assembled monolayer comprises the monomolecular compound of claim 1.

9. The all-solid-state battery of claim 8,
wherein the solid electrolyte layer comprises a sulfide-based solid electrolyte.

10. The all-solid-state battery of claim 8,
wherein the electrode layer comprises a copper foil.

11. A method for manufacturing a self-assembled monolayer, the method comprising the steps of:
(A) mixing CₓF₂ₓ₊₁OH (6≤x≤12) or CₓF₂ₓ₋₃H₅OH (6≤x≤12) with an aprotic polar solvent;
(B) mixing a reagent for imparting an anchoring property with the mixture of step (A) to produce a monomolecular compound;
(C) mixing the monomolecular compound with a solvent to prepare a coating solution; and
(D) applying the coating solution to an anode current collector.

12. The method of claim 11,
wherein the spacer of the monomolecule comprises at least one selected from the group consisting of C₈F₁₆, C₉F₁₈, C₁₀F₂₀, C₁₁F₂₂, C₁₂F₂₄, C₈H₄F₁₂, C₉H₄F₁₄, C₁₀H₄F₁₆, C₁₁H₄F₁₈, and C₁₂H₄F₂₀.

13. The method of claim 11,
wherein the aprotic polar solvent comprises at least one selected from the group consisting of tetrahydrofuran (THE), dimethylformamide (DMF), acetonitrile, and dimethyl sulfoxide (DMSO).

14. The method of claim 11,
wherein the reagent comprises at least one selected from the group consisting of phosphoryl chloride (POCl₃), potassium permanganate (KMnO₄), pyridinium chlorochromate, 2,2,6,6-tetramethylpiperidine 1-oxyl (TEMPO), and a CrO₃/H₂SO₄ mixed reagent.

15. The method of claim 11,
wherein step (B) is performed at a temperature of 0 to 100° C.

16. The method of claim 11,
wherein 15 to 20 mL of the aprotic polar solvent, 300 to 500 mg of the CₓF₂_{^{x}}₊₁OH or CₓF₂_{^{x}}₋₃H₅OH, and 150 mg to 6 g of the reagent are mixed.

17. The method of claim 11,
wherein, when the CₓF₂ₓ₊₁OH or CₓF₂ₓ₋₃H₅OH is n mol and the reagent is m mol, the ratio n/m is 0.5 or less.

18. The method of claim 11,
wherein, in step (C), the monomolecular compound is mixed at a concentration of 0.001 to 100 mM with the solvent.

19. The method of claim 18,
wherein the solvent in step (C) is tetrahydrofuran (THE) or a mixed solvent of isopropyl alcohol and an alkane.

20. The method of claim 19,
wherein the alkane comprises at least one selected from the group consisting of hexane (C₆H₁₄), heptane (C₇H₁₆), octane (C₈H₁₈), nonane (C₉H₂₀), decane (C₁₀H₂₂), undecane (C₁₁H₂₄), and dodecane (C₁₂H₂₆).
